(19) United States
(12) Patent Application Publication
(10) Pub. No.: US 2020/0256826 A1
(43) Pub. Date: Aug. 13, 2020

(54) PULSE-DRIVEN CAPACITIVE DETECTION FOR FIELD-EFFECT TRANSISTORS

(71) Applicant: UWM Research Foundation, Inc., Milwaukee, WI (US)

(72) Inventors: Junhong Chen, Whitefish Bay, WI (US); Arnab Maity, Milwaukee, WI (US); Xiaoyu Sui, Milwaukee, WI (US)

(21) Appl. No.: 16/758,354

(22) PCT Filed: Oct. 26, 2018
(86) PCT No.: PCT/US2018/057717

§ 371 Date: Apr. 22, 2020

(30) Foreign Application Priority Data
Oct. 27, 2017 (IN) 201721038194

(51) Int. Cl. G01N 27/41

(52) U.S. Cl. CPC G01N 27/41

(57) ABSTRACT

Systems and methods for detecting ions in samples. In one embodiment, the system includes a field-effect transistor sensor and an electronic controller. The field-effect transistor sensor is in contact with the sample and includes a first electrode and a second electrode. The electronic controller is coupled to the field-effect transistor sensor. The electronic controller is configured to apply a pulse wave excitation signal to the first electrode. The electronic controller is also configured to receive a response signal from the second electrode. The electronic controller is further configured to determine an electrical characteristic of the field-effect transistor sensor based on the response signal. The electronic controller is also configured to determine an amount of the ions in the sample based on the electrical characteristic of the field-effect transistor sensor.

### STATEMENT REGARDING FEDERALLY SPONSORED RESEARCH OR DEVELOPMENT

This invention was made with government support under grant No. IIP-1434059 awarded by the National Science Foundation. The Government has certain rights in the invention.

### CROSS-REFERENCE TO RELATED APPLICATIONS

This application claims priority to Indian Patent Application No. 201721038194, entitled “PULSE-DRIVEN CAPACITIVE DETECTION FOR FIELD-EFFECT TRANSISTORS (FET),” filed Oct. 27, 2017, the content of which is incorporated by reference herein in its entirety.

### BACKGROUND

Recently, lead contamination and related health hazards has raised a serious global issue. Direct intake of lead through drinking water on a daily basis can affect the central nervous system, and the hematopoietic, hepatic, and renal systems. An alarming level of increase of lead was found in the blood of people living in the city of Flint, Mich., USA due to the poor conditions of the water supply system (lead leak from the pipeline during the water conveyance). Conventional tests such as inductively coupled plasma mass spectrometry (ICP-MS), atomic absorption spectroscopy (AAS), and atomic emission spectrometry (AES) are costly due to their long procedure, bulky setup, and need for a professional operator. Electrochemical stripping analysis using voltammetry has also been successfully used for measuring various metal ions in trace level selectively with high reproducibility. However, it is limited by working electrode maintenance with proper cleaning, reduction/oxidation potential peak position drifting due to the aging of the reference electrode, and background current instability. Also, the presence of a high concentration of common metal ions in real water can significantly impact the results. Therefore, rapid, portable, low cost automated detection of lead ions in water is in great demand.

### SUMMARY

The disclosure provides a system for detecting ions in a sample. In one embodiment, the system includes a field-effect transistor sensor and an electronic controller. The field-effect transistor sensor is in contact with the sample and includes a first electrode and a second electrode. The electronic controller is coupled to the field-effect transistor sensor. The electronic controller is configured to apply a pulse wave excitation signal to the first electrode. The electronic controller is also configured to receive a response signal from the second electrode. The electronic controller is further configured to determine an electrical characteristic of the field-effect transistor sensor based on the response signal. The electronic controller is also configured to determine an amount of the ions in the sample based in part on the electrical characteristic of the field-effect transistor sensor.

The disclosure also provides a method for detecting ions in a sample. In one embodiment, the method includes contacting a field-effect transistor sensor with the sample. The method also includes applying a pulse wave excitation signal to a first electrode of the field-effect transistor sensor with an electronic controller. The method further includes the electronic controller receiving a response signal from a second electrode of the field-effect transistor sensor. The method also includes determining, with the electronic controller, an electrical characteristic of the field-effect transistor sensor based on the response signal. The method further includes determining, with the electronic controller, an amount of the ions in the sample based on the electric characteristic of the field-effect transistor sensor.

The disclosure also provides a pulse-driven capacitance measurement system including a field effect transistor (FET) to measure small concentrations of solutes in liquid and gas solutions. In general, the signal from the FET-based sensor device is transduced through resistance/current measurements considering the channel as a chemi-resistor.

Other aspects of the disclosure will become apparent by consideration of the detailed description and accompanying drawings.

### BRIEF DESCRIPTION OF THE DRAWINGS

FIG. 1 is a diagram of a detection system for detecting ions, in accordance with some embodiments.

FIG. 2 is a diagram of an electronic controller included in the detection system of FIG. 1, in accordance with some embodiments.

FIG. 3 is a flowchart of a method for detecting ions in a sample, in accordance with some embodiments.

FIG. 4 is a diagram of a field-effect transistor sensor, in accordance with some embodiments.

FIG. 5A is a diagram of a field-effect transistor measurement sensor with back-gate potential, in accordance with some embodiments.

FIG. 5B is a diagram of a pulse measurement circuit with zero back-gate potential, in accordance with some embodiments.

FIG. 5C is a graph of a square pulse wave and its transient waveform in the presence of DI water and Pb²⁺ solution.

FIG. 5D is a graph of normalized pulse waves.

FIG. 5E is a graph of waveform reproducibility in the presence of water and under drying conditions.

FIG. 6 is a diagram of a microcontroller-based pulsed-controlled portable capacitance measurement system, in accordance with some embodiments.

FIG. 7A is an image of reduced graphene oxide sheets bridging interdigitated electrodes at a low magnification.

FIG. 7B is an image of reduced graphene oxide sheets bridging interdigitated electrodes at a high magnification.

FIG. 7C is an image of a single layer graphene oxide channel on an electrode.

FIG. 7D is a graph of example Raman spectrum of graphene oxide nanosheets.

FIG. 7E is an image of sputtered gold nanoparticles on the surface of an aluminum oxide layer.

FIG. 7F is a graph of IV characteristics of an example field-effect transistor sensor.

FIG. 8A is a diagram of a pulse generation and measurement circuit, in accordance with some embodiments.

FIG. 8B is a diagram of a packaged portable meter with an integrated micro-sensor chip, in accordance with some embodiments.

FIG. 9A is a graph of a reversibility test in DI water and under drying conditions, in accordance with some embodiments.

FIG. 9B is a graph of a stabilization test of the sensor in DI water, in accordance with some embodiments.

FIG. 9C is a graph of a real time Pb²⁺ testing result with a microcontroller based measurement system, in accordance with some embodiments.

FIG. 10A is a graph of real-time resistance measurement data of a FET sensor in DI water for a background and stabilization test, in accordance with some embodiments.

FIG. 10B is a graph of resistance transients with bi-direction response for a lead ion.

FIG. 10C is a graph of resistance transients with bi-direction response for a lead ion.

FIG. 11A is a graph of response % versus concentration for an example calibration, in accordance with some embodiments.

FIG. 11B is a graph of real time transient data for a selectivity test for Hg²⁺ and mixed ions measurements, in accordance with some embodiments.

FIG. 12A is a graph of real-time measurement capacitance transients of common metal ions.

FIG. 12B is a graph of real-time measurement capacitance transients of heavy metal ions with mixed ions.

FIG. 13A is a graph of responses for Pb²⁺ and other individual and mixed metal cations.

FIG. 13B is a graph of testing results of real water samples.

FIG. 13C is a graph of real-time capacitance transients of different real water samples.

FIG. 13D is a graph of predicted lead ion concentrations from sensors with standard vales from ICP measurements, in accordance with some embodiments.

FIG. 14A is a diagram of a model of an insulated GFET structure with attached probes in a Pb²⁺ solution, in accordance with some embodiments.

FIG. 14B is a diagram of an equivalence circuit model of a field effect transistor structure, in accordance with some embodiments.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

Graphene as a representative 2D material is found to be promising for FET-based sensor applications due to its unique one atomic layer structure, high specific surface area, great signal/noise ratio, excellent mechanical strength, and small size. Chemical exfoliation in the liquid phase may produce one atomic layer thickness of ultrafine nanosheets in large scale from bulk graphite. The high surface area of graphene may be functionalized with various ligands to attract metal ions, biomolecules, and gas species for sensing applications. Micropatterned, protein-functionalized reduced graphene oxide (rGO) film may be used as a sensing semiconductor channel to realize lead ion (Pb²⁺) real-time detection. A self-assembly method for constructing an rGO sensing platform for Pb²⁺ monitoring may also been used. In general, the signal from such a FET-based sensor device is transduced through resistance/current measurements considering the channel as a chemi-resistor. One potential problem is that the continuous voltage across ultrathin 2D nanomaterials can generate heat and modify the intrinsic conductivity, which leads to a long stabilization time and signal drift. This unsaturated baseline with continuous drift is incompatible with rapid evaluation and interferes the response in the presence of analytes, thereby increasing the measurement error. In addition, the resistance/current response % (i.e., change percentage in resistance or current due to sensing events) to analytes is always relatively low, which may also lead to notable errors in practice. Examples of response % are illustrated below in Table 1.

TABLE 1
COMPARISON OF CAPACITANCE-BASED SENSING PERFORMANCE

| | Concentration | | |
|---|---|---|---|
| | Detected (nM) | | |
| Sensing Materials and | and Chemical | Response | |
| Test Method | Target | (%) | Selectivity^{α} (k_{target-other}) |
| rGo/GSH-AU NPs (DC) | 10 nM Pb²⁺ | 1.7% | k_{Pb}²⁺_{-Hg}²⁺(10 μM) = 3.3 |
| | | | k_{Pb}²⁺_{-Zn}²⁺ (10 μM) = 30 |
| Ti₃C₂-MXene (DC) | 100 nM\| | <0.01% | — |
| | dopamine | | |
| Graphene/olfactory | 0.04 × 10⁻⁶ nM | <2% | — |
| receptors (DC) | odorant (amyl | | |
| | butyrate) | | |
| PII2T-Si polymer/33- | 10,000 nM | 10% | k_{Hg}²⁺_{-Pb}²⁺ (1 μm) = 3.2 |
| based thiolated DNA | Hg²⁺ | | k_{Hg}²⁺_{-Zn}²⁺(1 μM) = 2.7 |
| probe-Au NPs (DC) | | | |
| Polypyrrole/rGO (DC) | 0.1 nM H₂O₂ | 1.4% | k_{H202(0.05 mM)-Uric acid(1 mM)} = 3.3 |
| | | | k_{H202(0.05 mM)-Ascorbic acid(1 mM)} = 5.7 |
| | | | k_{H202 (0.05 mM)-Ascorbic acid(1 mM)} = 22.8 |
| Pt NPs/rGO (DC) | 2.4 nM SsDNA | <0.01% | — |
| Bismuth-coated carbon | 1-150 ppb Pb²⁺ | — | — |
| electrodes (stripping | | | |
| voltammetry) | | | |
| rGO/GSH-AU NPs | 12 nM Pb²⁺ | 347% | k_{Pb}_{²⁺}_{-Hg}_{²⁺}_{, Fe}_{³⁺}_{, Mg}_{²⁺}_{, Zn}_{²⁺}_{, Na}_{⁺}_{(48 nM)} ~(10-30) |
| (Pulse) | | | |

^{α}k_{target-other} is the ratio of signal response to target and other chemicals.

Therefore, an alternative strategy is needed to address these issues. The continuous voltage across the sensor can be replaced with a periodic square pulse wave (for example, using a function generator). In the presence of analytes, the sensing signal across the sensor quickly changes to stable slanting charge/discharge transients that represent a high capacitive influence. Upon drying the solution, the signal again regains its pure square wave instantly. Further, a pulsed signal in combination with capacitance measurement may be used to capture the rapid change in a signal in the presence of analytes using, for example, a graphene field-effect transistor (GFET) sensor. A pulsed capacitance measuring system with a programmed microcontroller may be used to evaluate the sensing performance of the disclosed system. The disclosed capacitance-based portable device with simple droplet-based measurement system shows rapid stabilization in background deionized water (DI water), negligible drift, high sensitivity, and selectivity toward lead ion detection in real-time measurements.

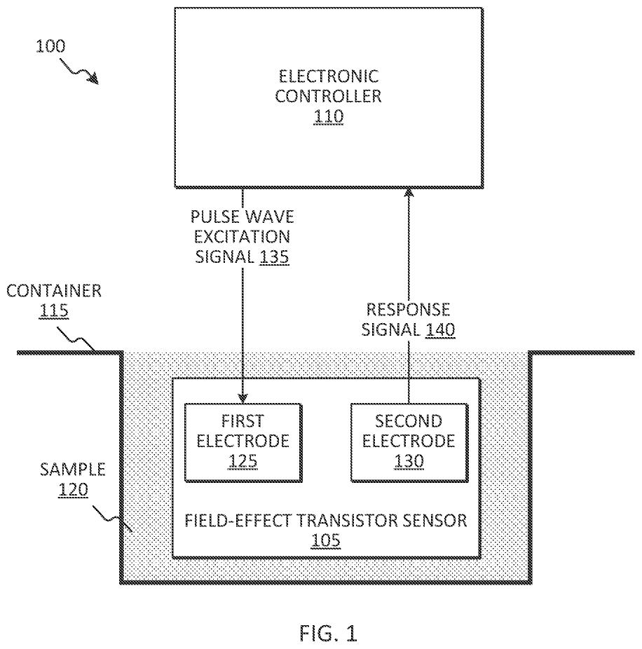

FIG. 1 is a diagram of one example embodiment of a detection system 100. In the embodiment illustrated in FIG. 1, the detection system 100 includes a field-effect transistor sensor 105 and an electronic controller 110. Electrical characteristics of the field-effect transistor sensor 105 change when the field-effect transistor sensor 105 interacts with an analyte. For example, the capacitance of the channel of the field-effect transistor sensor 105 changes when the field-effect transistor sensor 105 is submerged in a container 115 containing a sample 120 (or solution) that includes lead ions, as illustrated in FIG. 1. In the embodiment illustrated in FIG. 1, the sample 120 is a liquid medium. Alternatively or in addition, the sample 120 may include a different medium such as a gas medium.

The field-effect transistor sensor 105 illustrated in FIG. 1 includes a first electrode 125 (for example, a source terminal) and a second electrode 130 (for example, a drain terminal). The electronic controller 110 is coupled to field-effect transistor sensor 105. The electronic controller 110 applies a pulse wave excitation signal 135 to the first electrode 125. Responsive to the pulse wave excitation signal 135, the field-effect transistor sensor 105 generates a response signal 140. The electronic controller 110 receives the response signal 140 via the second electrode 130.

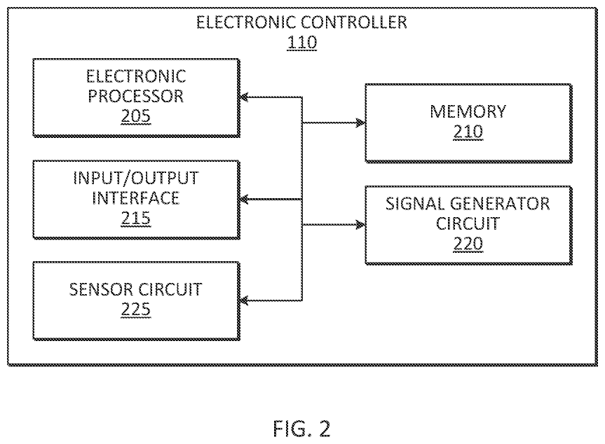

FIG. 2 is a diagram of one example embodiment of the electronic controller 110. In the embodiment illustrated in FIG. 2, the electronic controller 110 includes an electronic processor 205 (for example, a microprocessor), memory 210, an input/output interface 215, a signal generator circuit 220, a sensor circuit 225, and a bus. In alternate embodiments, the electronic controller 110 may include fewer or additional components in configurations different from the configuration illustrated in FIG. 2. The bus connects various components of the electronic controller 110 including the memory 210 to the electronic processor 205. The memory 210 includes read only memory (ROM), random access memory (RAM), an electrically erasable programmable read-only memory (EEPROM), other non-transitory computer-readable media, or a combination thereof. The electronic processor 205 is configured to retrieve program instructions and data from the memory 210 and execute, among other things, instructions to perform the methods described herein. Alternatively or in addition, the memory 210 is included in the electronic processor 205.

The input/output interface 215 includes routines for transferring information between components within the electronic controller 110 and other components of the detection system 100, as well as components external to the detection system 100. The input/output interface 215 is configured to transmit and receive signals via wires, fiber, wirelessly, or a combination thereof. Signals may include, for example, information, data, serial data, data packets, analog signals, or a combination thereof.

The signal generator circuit 220 is configured to generate the pulse wave excitation signal 135. As used herein, the term “pulse wave” is defined as a non-sinusoidal waveform that includes square waves (i.e., duty cycle of 50%) and similarly periodic but asymmetrical waves (i.e., duty cycles other than 50%). In some embodiments, the pulse wave excitation signal 135 includes a direct current square wave. As used herein, the term “direct current square wave” is defined as a signal with a constant polarity and in which the amplitude of the signal alternates at a substantially steady frequency between fixed minimum and maximum values, with substantially the same duration at the minimum and maximum values. In alternate embodiments, the pulse wave excitation signal 135 includes a direct current rectangular wave. As used herein, the term “direct current rectangular wave” is defined as a signal with a constant polarity and in which the amplitude of the signal alternates at a substantially steady frequency between fixed minimum and maximum values, with different durations at the minimum and maximum values. The pulse wave excitation signal 135 is distinct from a continuous direct current signal in which the voltage of the signal is substantially constant. The pulse wave excitation signal 135 is also distinct from a pulsed (or pulsating) direct current signal in which the voltage of the signal changes but is still substantially constant. In some embodiments, the signal generator circuit 220 includes, among other things, a function generator, resistors, rectifiers, amplifiers, digital-to-analog converters, voltage-to-current converters, or a combination thereof.

The sensor circuit 225 is configured to measure one or more electrical characteristics of the response signal 140 such as voltage and current. In some embodiments, the sensor circuit 225 includes, among other things, an oscilloscope, resistors, filters, amplifiers, analog-to-digital converters, current-to-voltage converters, or a combination thereof.

The electronic controller 110 is configured to determine an electrical characteristic of the field-effect transistor sensor 105 based on the response signal 140. For example, the electronic controller 110 may determine a capacitance of the field-effect transistor sensor 105 based on the response signal 140. In some embodiments, the electronic controller 110 is configured to determine an electrical characteristic of the field-effect transistor sensor 105 based on a signal characteristic of the response signal 140. For example, the electronic controller 110 may determine a capacitance of the field-effect transistor sensor 105 based on a time constant of the response signal 140. In some embodiments, the electronic controller 110 is configured to determine a signal characteristic of the response signal 140 based on a change in an electrical characteristic of the response signal 140. For example, the electronic controller 110 may determine a time constant of the response signal 140 based on a change in the voltage of the response signal 140. In some embodiments, the electronic controller 110 is configured to determine an electrical characteristic of the response signal 140 using measurements (for example, voltage and current measurements) from the sensor circuit 225. The electronic controller 110 is configured to determine an amount of the ions in the sample 120 based on an electric characteristic of the field-effect transistor sensor 105. For example, the electronic controller 110 may determine an amount of ions in the sample 120 based on the capacitance of the field-effect transistor sensor 105.

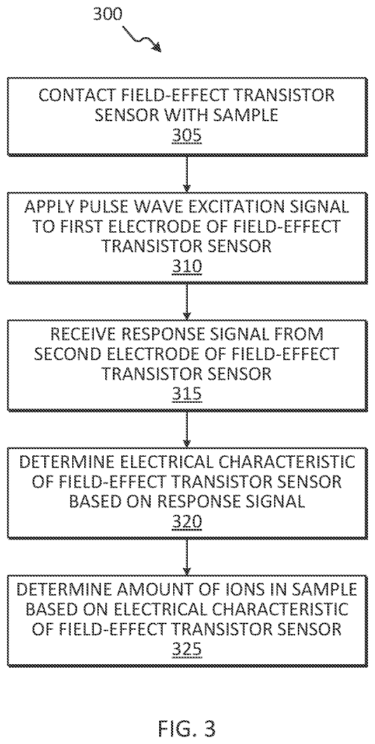

FIG. 3 illustrates an example method 300 for detecting ions in a sample. The method 300 is described with respect to the components illustrated in FIGS. 1 and 2. However, it should be understood that in some embodiments, all or portions of the method 300 may be implemented with other components. At block 305, the field-effect transistor sensor 105 is contacted with the sample 120. For example, in some embodiments, a drop of a liquid solution containing lead is poured onto the field-effect transistor sensor 105. At block 310, the electronic controller 110 applies the pulse wave excitation signal 135 to the first electrode 125 of the field-effect transistor sensor 105. For example, in some embodiments, the signal generator circuit 220 generates a direct current square wave signal that is applied to the first electrode 125 of the field-effect transistor sensor 105. At block 315, the electronic controller 110 receives the response signal 140 from the second electrode 130 of the field-effect transistor sensor 105. At block 320, the electronic controller 110 determines an electrical characteristic of the field-effect transistor sensor 105 based on the response signal 140. For example, in some embodiments, the electronic controller 110 determines a capacitance of the field-effect transistor sensor 105 based on the response signal 140. At block 325, the electronic controller 110 determines an amount of the ions in the sample 120 based on the determined electric characteristic of the field-effect transistor sensor 105. In some embodiments, the ions are lead ions. Alternatively or in addition, the ions are ions of another analyte such as mercury.

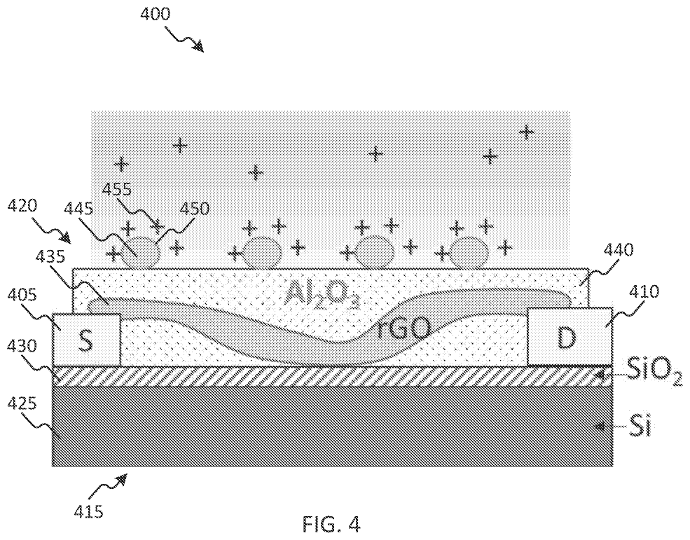

FIG. 4 is a diagram of one example embodiment of a field-effect transistor sensor 400. In the embodiment illustrated in FIG. 4, the field-effect transistor sensor 400 includes a source terminal 405, a drain terminal 410, a back gate 415, and a top gate 420. The source terminal 405 and the drain terminal 410 comprise highly conductive materials such as noble metals (for example, Au, Pd, Ag, and Pt) or graphene. The back gate 415 is used to characterize the electronic properties (for example, current on/off ratio) of the field-effect transistor sensor 400. In the embodiment illustrated in FIG. 4, the back gate 415 includes a conductive under-layer 425 (such as Si or a conductive polymer) and an over-layer 430 (such as SiO₂) to create a capacitive effect. In some embodiments, the back gate 415 is manufactured by cutting a silicon ingot and generating the over-layer 430 on the silicon wafer in situ. The top gate 420 isolates the analytes from the electrodes and prevents short circuit current from the solvent or other conducting species in the solvent. The top gate 420 can also prevent non-specific adhesion of analytes to the channel material. In the embodiment illustrated in FIG. 4, the top gate 420 includes a reduced graphene oxide layer 435 coated with a passivation layer 440 (for example, SiO₂ or other insulating metal oxide including Al₂O₃, TiO₂, and SrTiO₃). The reduced graphene oxide layer 435 acts as a conducting channel suspended above the back gate 415 and electrically connects the source terminal 405 and the drain terminal 410. Gold nanoparticles 445 are in contact with the passivation layer 440. In some embodiments, the gold nanoparticles are discrete nanoparticles. One or more probes 450 are bound to each of the gold nanoparticles 445. Lead ions 455 bond with the probes 450.

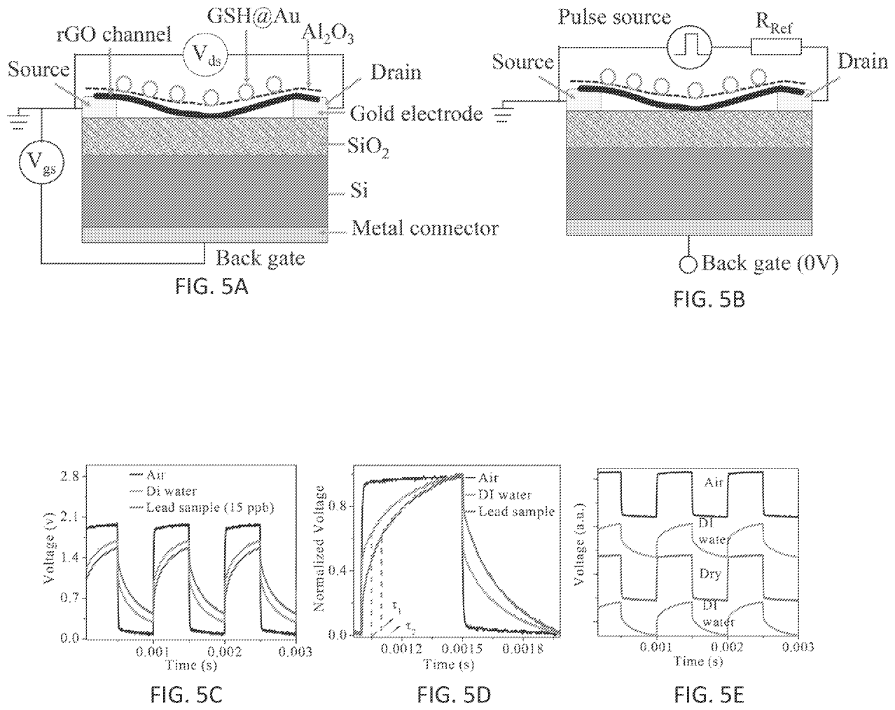

In some embodiments, a square pulse wave source is used to detect Pb²⁺ ion concentrations using a graphene FET device as shown in FIGS. 5A and 5B. During the sensing, the back gate voltage is removed and Pb²⁺ ions adsorbed by a glutathione (GSH) probe from the top gate create a voltage effect through an induced positive electrostatic field. The capacitance measurement is performed with a square pulse wave-based technique that calculates the time constant of the morphed signal across the drain-source interface of the sensor which is connected in series with a reference resistor. With the known value of resistance (Rref), the capacitance value can be obtained by measuring the time constant (τ). In some embodiments, a standard function generator generates the short duration square pulse and the FET sensor output signal resembles a perfect square wave in air. In some embodiments, the signal changes across the drain source interface in the presence of water and the addition of aqueous metal ions are visualized using a digital oscilloscope. An example of a square pulse wave and its transient waveform in the presence of deionized (DI) water and Pb²⁺ is illustrated in FIG. 5C. When a drop of deionized water is exposed on the surface of the sensor, the signal quickly becomes slanted. While not wishing to be bound by a particular theory, the voltage transient across the sensor looks like a capacitive behavior in a RC circuit due to slow charging and discharging. The time constant (τ) is estimated by calculating the time to reach 63.2%=1/e value of the maximum change in the charging/discharging voltage. Upon injection of the Pb²⁺ ion solution, the transient becomes more slanted due to the adsorption of lead ions by the GSH probes on the sensor surface which change the capacitance and the corresponding time constant. FIG. 5D shows the normalized plot of the signal in the presence of air, water, and a Pb²⁺ solution. The time constant of the sensor in water (τ₁) and in a lead solution (τ₂) increased systematically with respect to the blank sensor (air). The responses in DI water and Pb²⁺ sample from blank sensor state (air) are also very fast. The square wave is recovered upon removal of water sample as illustrated in FIG. 5E. In view of this, it is understood that this transient information through relative change in capacitance may be utilized for an FET type of water sensor to quantify the Pb²⁺ concentration.

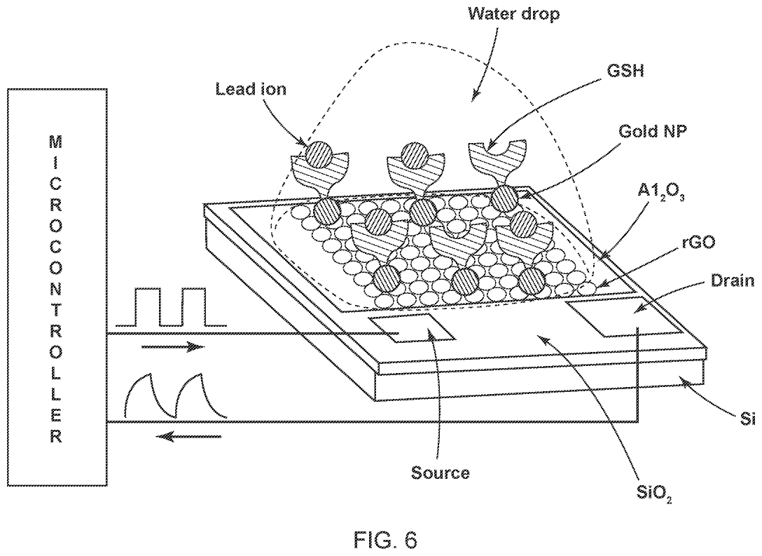

In some embodiments, a pulse-driven capacitance measurement system is a controlled by a microcontroller or other computerized system, including, for example, a miniaturized Arduino-based micro-controller. FIG. 6 is a diagram of on example embodiment of a pulse-driven capacitance measurement system is a controlled by a microcontroller. This microcontroller or similar computerized system may be configured to manage any or all elements including pulse generation, capacitance signal measurement, continuous data recording of the FET sensor, or a combination thereof.

In some embodiments, the pulse-driven driven capacitance system may be used to measure concentration including both insulated and non-insulated gated structures such that the structure is useful to sense analytes in liquid, gas, or solid mixtures. At the minimum, FET structure embodiments include electrical connectivity (source and drain terminals), a back gate, and a top gate. The source and drain materials may be highly conductive materials, including noble metals (Au, Pd, Ag, Pt), graphene, or similar. For sensors embodiments, the back gate may be used to characterize the electronic properties (for example, current on/off ratio) of the sensor and generally embodiments are made up of two layers, a conductive under-layer such as Si, conductive polymer or other and a SiO₂ over-layer or other to create a capacitive effect. Embodiments are generally manufactured by cutting a Si ingot and generating the SiO₂ over layer on the Si wafer in situ. The channel embodiments are the material systems created to specifically sense an analyte within a gas, liquid, or solid mixture. In some cases, a top gate embodiment can be necessary to isolate the analytes from the electrodes and/or to prevent short circuit current from the solvent or other conducting species in the solvent. This may also prevent non-specific adhesion of analytes to the channel material. Example top gate material embodiments are made from SiO₂ or other insulating metal oxide including Al₂O₃, TiO₂, and SrTiO₃.

In some embodiments, a pulse-driven capacitance measurement system may be used in an FET based sensing platform in which the graphene channel material is replaced with other semiconductors including silicon, phosphorene (black phosphorous), molybdenum sulfide and other transition metal dichalcogenides (for example, WS₂, WSe₂, and WTe₂). Improved semiconducting properties (i.e., on/off ratio) improve the sensing performance.

In some embodiments, a pulse-driven capacitance measurement system may be applied to FET sensors to measure analytes in liquid. These analytes may be biological or non-biological in nature, and the liquids may be polar or non-polar. In some embodiments, the FET sensor as described herein is equipped with a suitable sensing probe, such that the sensor may be used to detect ions in various samples. For example, samples suitable for such detection include, but are not limited to, bacteria, viruses, metal ions and complexes involving one or more ions selected from Ag⁺, Ca²⁺, Cu²⁺, Cd²⁺, Cr₂O₇²⁻, Fe²⁺, Fe³⁺, HAsO₄²⁻, Hg²⁺, Mg²⁺, Na⁺, Pb²⁺, and Zn²⁺; uranium solutions and ion complexes; and samples involving nonmetal ions, such as PO₄³⁻, NO₃⁻, polymeric ions, pesticide ions, methylene blue ions, or bisphenol A ions. The probe material system may be generated on the channel material. For example, a family of chemical probe materials may be generated using known methods to sensitize a graphene channel to bacteria, viruses, Ebola, E. coli, and metal ions. Probes for detecting biomarkers for cancer or other disease states may also be used.

When detecting analyte concentrations in water (or other solutes), the water can act as a conducting channel for a FET in a FET based sensing platform. Thus, to separate analytes from the electrodes of the FET, a metal oxide passivation layer (for example, aluminum oxide) can be added to the FET. For example, the atomic layer deposition method for adding a passivation layer to an outer surface of a FET described in U.S. Pat. No. 9,676,621 issued on Jun. 13, 2017 (the entire content of which is hereby incorporated by reference) may be used. Using a passivation layer may exclude the charge transfer and prevent Au electrode from interaction with modified glutathione (GSH) probes.

In some embodiments, a pulse-driven capacitance measurement system may be used in concert with the FET graphene-based platform to realize real-time monitoring of ions of interest, including, but not limited to, HAsO₄²⁻, Hg²⁺, Pb²⁺, PO₄³⁻, individually or together in water at low concentrations (˜2.5-100 ppb) with rapid stabilization (˜1 s), negligible signal drift, high sensitivity, and selectivity. For example, the FET graphene-based platform described in U.S. patent application Ser. No. 15/500,943 filed on Feb. 1, 2017 (the entire content of which is hereby incorporated by reference) may be used. Selectivity may be adjusted by changing the specific probe on the top gate. For several FET systems, the selectivity to different analytes may be adjusted by choosing probes that are sensitized to the analyte of interest (for example, for bacteria).

In some embodiments, the pulse-driven capacitance measurement system may be employed to quantify various biological pathogens (for example, Ebola and E. coli) using FET sensors by modifying the respective antibodies and proteins on the top gate. In some embodiments, proteins may also be sensed, these including human IgG and animal proteins including ferritin. A specific pathogen, protein, or other interaction may be detected using the FET directly in blood samples and serum samples using the pulse-driven capacitance method in some embodiments.

In some embodiments, a pulse-driven capacitance FET measurement system may measure Pb²⁺ presence in samples from natural and municipal sources. Pulse-driven capacitance measurements are within the error of the values measured by inductively coupled plasma reference measurements for tap water samples taken from the city of Flint, Mich., the city of Milwaukee, Wis., and natural water samples from Lake Michigan and the Milwaukee River. In some embodiments, viable analytes that may induce a change in an electric field including bacteria, viruses, metal ions and complexes involving these ions, Ag⁺, Ca²⁺, Cu²⁺, Cd²⁺, Cr₂O₇²⁻, Fe²⁺, Fe³⁺, HAsO₄²⁻, Hg²⁺, Mg²⁺, Na⁺, Pb²⁺, Zn²⁺, uranium solutions and ion complexes, non-metal ions, PO₄³⁻, NO₃⁻ polymeric ions, like pesticides, methylene blue, bisphenol A are suitable for detection by FET sensors.

In some embodiments, the pulse-driven capacitive FET measurement system can quantify CO, NH₃, H₂S, C₄H₁₀, organophosphates (i.e., nerve gas), and trinitrotoluene through the use of a non-passivated graphene channel. Depending on the affinity of the gas with the graphene channel and the different dielectric constants of gas species, a selective detection of gas may be achieved with present platform. 2D materials (including phosphorene and transition metal chalcogenides) may also be used in the same platform to detect gas and chemical vapors. In some embodiments, the pulse-driven capacitive FET measurement system includes a known FET based gas sensor.

In some embodiments, fine powdered, solid chemicals dispersed in air may also be detected using the disclosed pulse driven capacitive FET measurement system, including aerosol-like dispersants in air. For example, solid chemical analytes like melamine may be detected using an organic diode structure based on a horizontal side-by-side p-n junction which is a structure similar to a FET.

In some embodiments, heavy metal ions and/or complexes may be detected in drinks and beverages (for example, tea, coffee, and fruit juice) using the disclosed pulse-driven capacitance controlled 2D materials-based FET system. An application embodiment may include continuous, real-time monitoring and quality assurance of food products during production. For example, reduced graphene oxide modified electrode systems may be used to detect Pb²⁺ in juice, preserved eggs, and tea samples.

In some embodiments, a pulse-driven capacitance FET measurement method may be used as a strategy to allow larger device to device variability in FET-based devices. Resistive-based concentration measurement systems are less sensitive than the pulse-driven capacitive method described herein. For the resistive measurements, at the analyte concentrations often critical for measuring water and air contamination, the error becomes of similar order of magnitude to the measurement. To make the measurement meaningful, all other sources of error, including device to device variability have had to be minimized. The sensitivity of the pulse-driven capacitance FET is two to three orders of magnitude higher, and for the same measurements, allowing for industrially-relevant manufacturing tolerances.

The following is a description of the chemical and materials that may be used in the disclosed detection system in accordance with some embodiments. A single layer graphene oxide (GO) water dispersion (10 mg/mL) with the size of 0.5-2.0 μm is used. Cysteamine (AET), L-Glutathione reduced (GSH) and metal chloride or nitrate salts are used to prepare Pb²⁺, Hg²⁺, Cd²⁺, Ag⁺, Fe³⁺, Na⁺, Mg²⁺, and Zn²⁺ solutions. Since the main forms of arsenic within a 2-11 pH range may be H₂AsO₄⁻, HAsO₄²⁻ in natural water, disodium hydrogen arsenate (Na₂HAsO₄) may be used to prepare a test solution. The inductively-coupled plasma mass spectrometer (ICP-MS) method may be used to quantify the prepared metal ion solutions with an error less than 5%. Real water samples may be filtered with Millipore filters to remove larger particles, algae, and other biological contaminants before sensing tests, and the actual concentrations of various metal ions are analyzed by ICPMS. Savannah S 100 atomic layer deposition (ALD) may be used to deposit Al₂O₃ layer with a precise thickness control. Au nanoparticles (Au NPs) may be sputtered with an Au target by an RF (60 Hz) Emitech K575x sputter coater machine.

The following is a description of an example sensor chip fabrication method that may be used for the disclosed detection system in accordance with some embodiments. Au interdigitated electrodes with finger-width and inter-finger spacing of 1.5 μm and a thickness of 50 nm is fabricated on a 100 nm SiO₂ layer coated silicon wafer by a lithographic method. An electrostatic self-assembly method is used to deposit GO sheets on electrodes. First, the Au electrodes is incubated in AET solution and then rinsed with DI water to attach a monolayer of AET on the Au electrodes. Second, the modified Au electrodes is immersed in DI water diluted GO solution to obtain single layer GO attachment through the electrostatic interaction between the positively charged amino groups of AET and the negatively charged GO sheets in solution. Unanchored GO sheets are removed through rinsing with DI water. A quick annealing process for 10 min at 400° C. in a tube furnace with argon gas is used to both reduce the GO and improve the contact between the GO and the electrodes, after which the samples are cooled to room temperature spontaneously. Next, a thin Al₂O₃ passivation layer is deposited on the sensor surface by atomic layer deposition (ALD) with trimethyl-aluminum (TMA) and water precursors at 100° C. Uniformly distributed and high density of Au NPs are sputtered on the Al₂O₃ as the anchors for chemical GSH probes. A GSH water solution is dropped on the top of the sensing area, and the devices is incubated at room temperature for 1 hour, then rinsed with DI water to remove extra GSH and dried with compressed air before heavy metal ion detection. The electrical properties are characterized by a Keithley 4200 semiconductor characterization system.

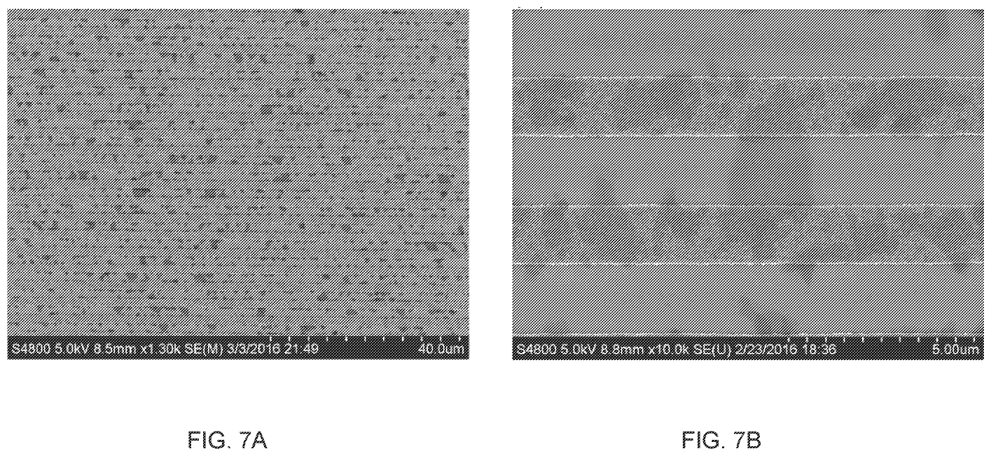

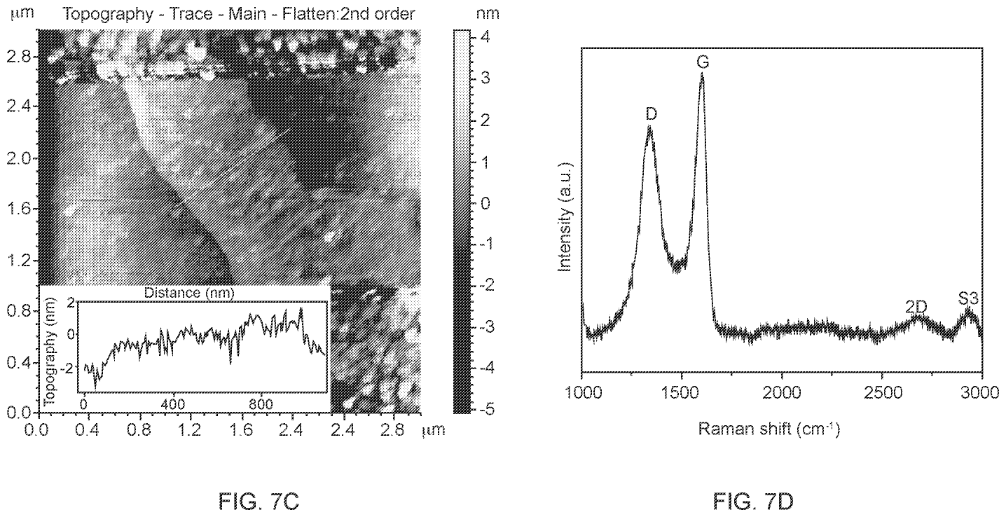

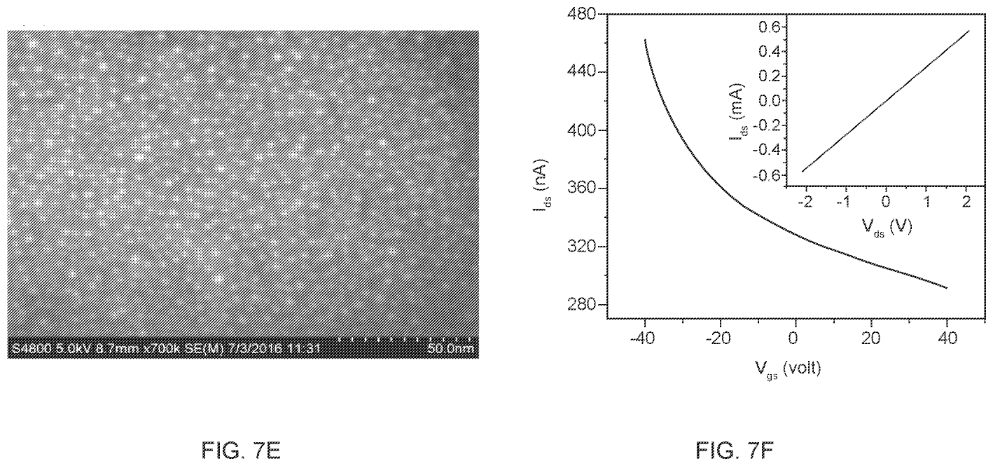

FIG. 7A shows an example scanning electron microscope (SEM) image of an overall reduced graphene oxide (rGO) distribution in low magnification. As identified, lots of GO flakes are deposited on the interdigitated electrodes quite uniformly without accumulation. The deposited GO shows a transparent well (single layer like impression) and connects as a channel between source-drain gold interdigitated electrodes. Because of the strong attraction between the positively charged AET on the gold fingers and the negatively charged GO sheets, the GO sheets prefer to deposit on the fingers and may be maintained during the following rinse process, while those GO sheets sitting on the gap (SiO₂ substrate) are removed completely during rinsing. FIG. 7B shows that most of the small GO flakes attach on the gold fingers, and only those flakes that are large enough may act as the single layer channels finally. This feature helps to get rid of the influence of accumulation of small GO flakes which increases the contact resistance in the electronic device, thereby decreasing the signal-to-noise ratio. An example AFM image of an as-deposited GO nanosheet with line scan of calculated height is shown in FIG. 7C. The typical thickness of the nanosheet bridging the electrode gap is found to be about 1 nm, which confirms the single atomic layer thickness of the deposited GO sheet. In the Raman spectrum (see FIG. 7D), two typical peaks at 1344 cm⁻¹ and 1603 cm⁻¹ are assigned to D-band and G-band of deposited GO nanosheets, respectively. The D-band in the spectrum indicates the presence of disorder in GO because of oxygen-containing groups and defects on the carbon basal plane. Also, 2D-band and S3 peaks can be observed at 2670 cm⁻¹ and 2923 cm⁻¹, respectively. Thus, the applied AET modification of the electrodes and GO solution immersion method is an easy and self-limiting method to construct single layer rGO channel on interdigitated electrodes directly, resulting in attractive semiconductor properties of the device.

After GO deposition and thermal annealing treatment, a thin layer of Al₂O₃ is used to separate analytes from rGO channels to protect the device electrical stability and exclude the charge transfer between the ions and the semiconductor channels. The Al₂O₃ may also passivate the gold finger electrodes from interaction with further modified GSH probes (the probes may be anchored only on the Au NPs sputtered next) resulting in more effective probes on the top of the rGO channels to improve the sensor performance. After the Al₂O₃ deposition, due to the electron accumulation of the insulating Al₂O₃ at a high voltage, it may be hard to see the GO sheets on the electrodes. FIG. 7E shows the uniform isolated Au NPs distribution after Au sputtering. The size of the Au NPs is about 3-5 nm, and the density is high, which facilitates more probe modification to enhance the sensor sensitivity in the sensing test.

To characterize the FET property of the sensor, the drain current (I_{ds}) may be measured as a function of sweeping back gate voltage from −40 to 40 V. A smooth p-type FET curve with an on-off ratio ˜1.6 is achieved from the single layer rGO channel (see FIG. 7F). A linear I_{ds}-V_{ds} relationship of the sensor for the drain voltage (V_{ds}) ranging from −2 to +2 V indicates the good ohmic contact between the rGO channel and the gold electrodes (shown in the inset of FIG. 5F). The measurement circuit diagram is shown in FIG. 5A.

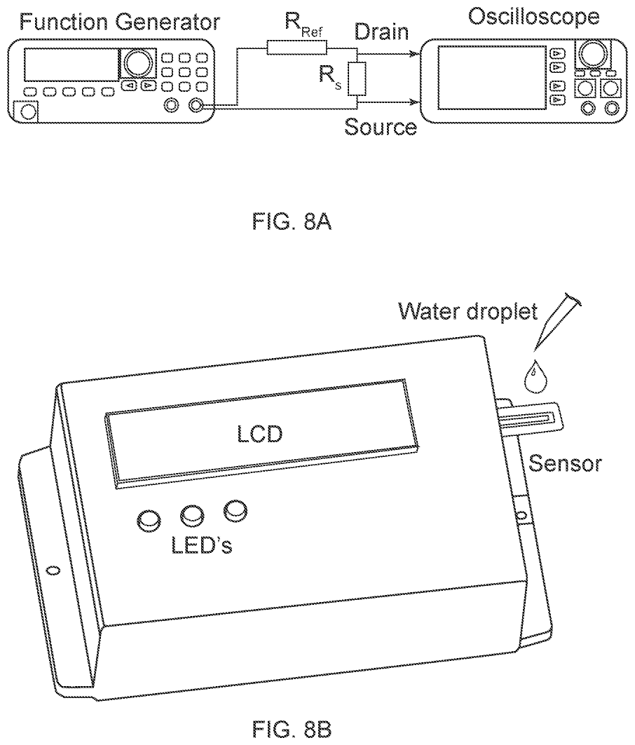

The capacitance measurement is performed with a square pulse wave-based technique that calculates the time constant of the morphed signal across the drain-source interface of the sensor which is connected in series with a reference resistor (Rref) (see FIG. 5B). With the known value of resistance (Rref), the capacitance value may be obtained through time constant (τ) measurement. A standard function generator may be used to generate the short duration square pulse and a digital oscilloscope may be used to visualize how the signal is changed across the drain source interface in the presence of water and metal ion sample (see FIG. 8A). As shown in FIG. 5C, when the FET sensor is in air the output signal resembles a perfect square wave. However, when a drop of DI water is exposed on the surface of the sensor, the signal is quickly changed and looks like a slow slanted transient as anticipated. The time constant (τ) is estimated by calculating the time to reach 63.2% value of the maximum change in the charging/discharging voltage. Upon injection of the Pb²⁺ ion solution, the transient becomes more slanted due to the adsorption of lead ions by the chemical GSH probes on the sensor surface which change the capacitance and the corresponding time constant. FIG. 5D shows the normalized plot of the signal in the presence of air, water, and Pb²⁺ solution. The time constant of the sensor in water (τ₁) and lead solution (τ₂) increased systematically with respect to the blank sensor. The responses in DI water and Pb²⁺ sample from blank sensor state (air) are also very fast. Interestingly, when the water was removed, the signal again regains its original square waveform (see FIG. 5E). Therefore, the change in signal is influenced by the change in larger dielectric constant of water (˜80) compared with air (˜1) that affects the gate capacitance of the sensor under test. In view of this, it is understood that this transient information through relative change in capacitance may be utilized for an FET type of water sensor to quantify the Pb²⁺ concentration.

For real-time application, a miniaturized Arduino-based microcontroller may be used and programmed for pulse generation, capacitance signal measurement, and continuous data recording from this FET-type rGO sensor. A portable device with a droplet-based measurement system has also been developed. FIG. 6 shows the schematic of the measurement platform in accordance with some embodiments. The capacitance value is displayed in the LCD. The stray capacitance is approximately 24 pF, determined through calibrations of measuring other capacitance values and compared with multimeter readings. This hand-held prototype consisting of LCD, LEDs, and in house cavity for sensor connecting is integrated and schematically shown in FIG. 8B. The response % of this chemo-capacitance-based FET may be defined as

$$R ( \% ) = \frac{C - {C}_{0}}{{C}_{0}} \times 100 \% \qquad ( 1 )$$

where C₀ is the capacitance in DI water as background and C is the charged capacitance in the presence of various metal ion solution.

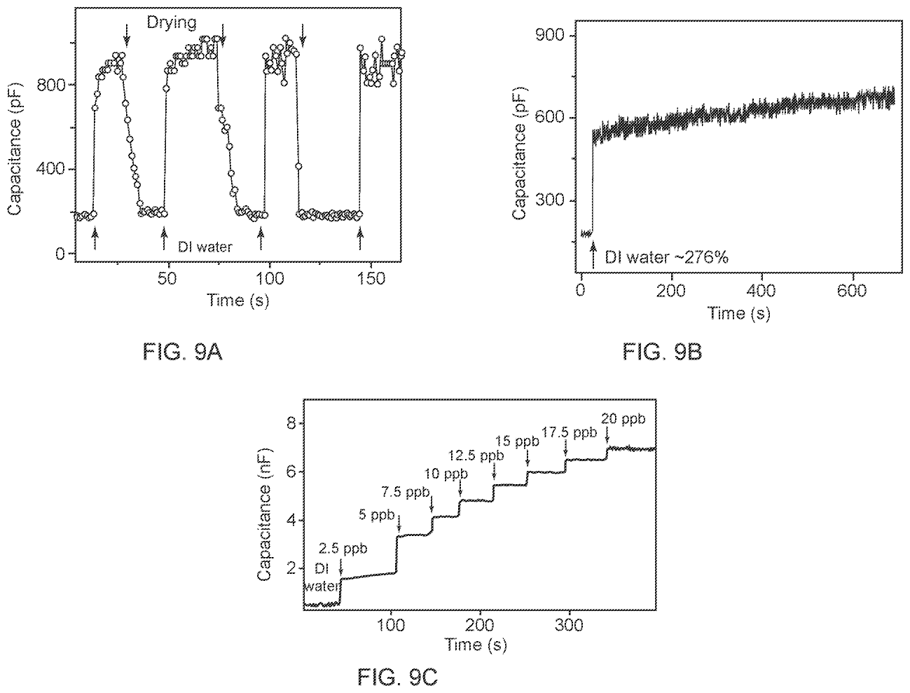

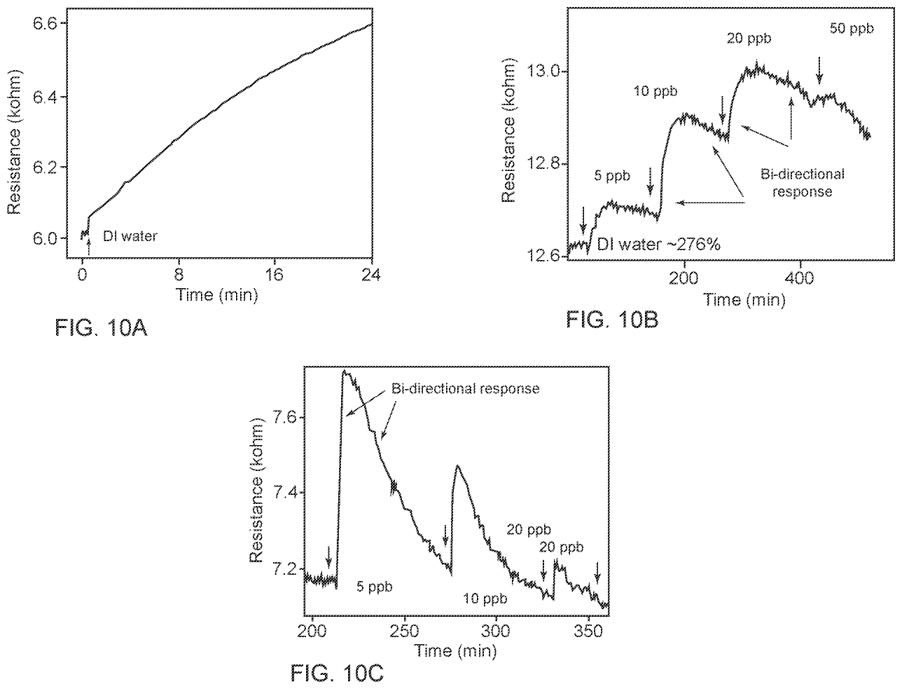

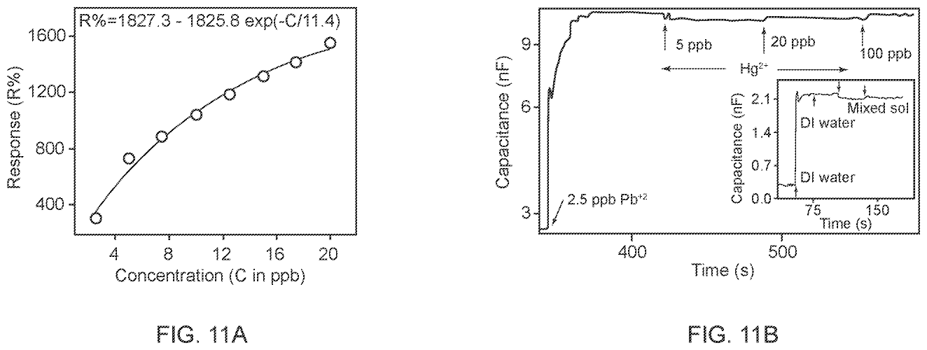

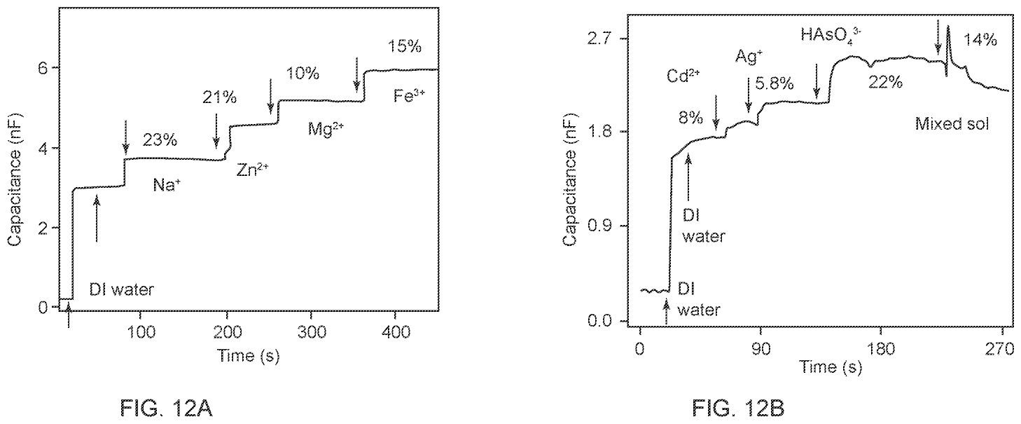

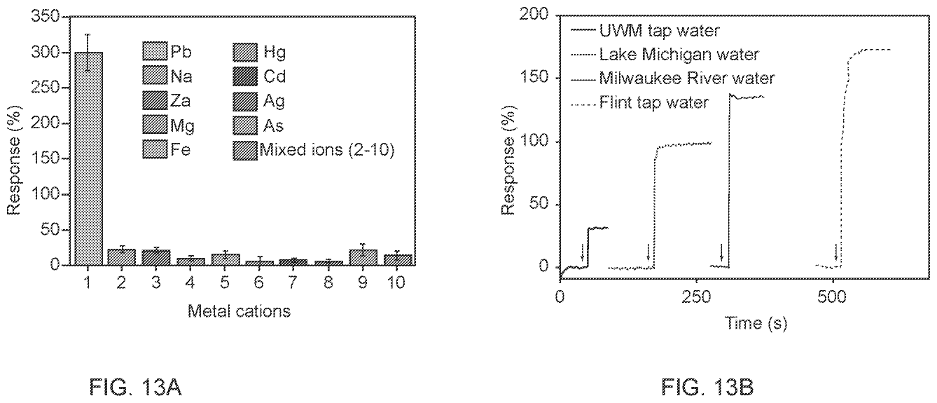

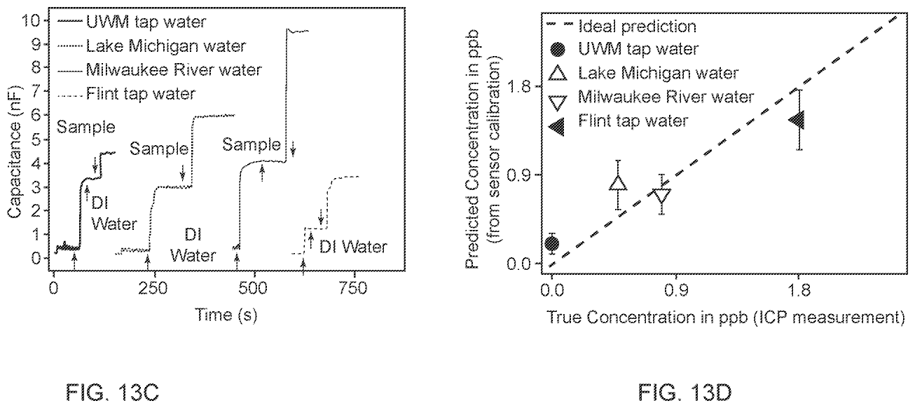

FIG. 9A displays the measured capacitance by the meter with multiple cycles of dropping and drying of DI water on the sensor surface. When the DI water (2 μL) is dropped on the sensor surface, an instant and large change (˜5 times of the dry sensor) in capacitance is found. It quickly goes to saturation within 1-2 seconds. When DI water is taken out, the capacitance quickly reverts to its original value under dry condition. Several cycles of dropping and drying are performed to demonstrate the highly repeatability of the change, which may be attributed to the instant variation of dielectric environment as mentioned above. Interestingly, a quick stabilization with negligible drift in capacitance in the presence of DI water over time (10 minutes) is found for this arrangement (see FIG. 9B), compared with much longer stabilization time caused by signal drifting in a common resistance measurement. This signal drifting is likely due to the modification of the graphene channel conductivity as a result of Joule heating with the continuous voltage across the ultrathin graphene sensor surface. Once a stable baseline in DI water is obtained, Pb²⁺ solution is injected on the sensor surface (see FIG. 9C). Again, the change in capacitance in the presence of Pb²⁺ is instantaneous (response time ˜1 second) and a very high response % (R % ˜347%) was found even for a low concentration of 2.5 ppb. These advantages make the disclosed sensing platform exceed common resistance measurement of the FET sensors where significantly longer stabilization time is always needed and the signal continuously drifts in the presence of analytes, which causes unfavorable lower response %, bidirectional response, slower detection, and larger error. For example, FIG. 10A shows the resistance transient data of the GFET sensor in the presence of DI water acquired with a continuous voltage mode. As shown in the figure, it takes long time to reach a stable value before conducting a lead ion test and is not suitable for rapid testing. FIGS. 10B and 10C show the typical Pb²⁺ testing resistance transient data taken with continuous voltage mode. The resistance change in the presence of Pb²⁺ sometimes shows a bi-directional response. When the Pb²⁺ solution is injected sequentially, a step-like, fast increase in capacitance corresponding to the increases of Pb²⁺ concentrations occurs. As the maximum contaminant limit (MCL) by the Unites States Environmental Protection Agency (EPA) for lead in drinking water is 15 ppb, the sensor may easily detect lead concentrations lower than this limit and works well around this critical value for real-world application. The relationship between concentration and response % fits well with an exponential function (see FIG. 11A), and is loaded into the controller. Then, the concentration prediction may be shown in the LCD of the meter (see FIG. 8B), accompanied by LED indicators, Safe (Green (0-5 ppb)), Moderate (Yellow (5-15 ppb)), and Danger (Red (>15 ppb)). The sensor exhibits a much higher response to Pb²⁺ compared with other common cations and heavy metal contaminants (Zn²⁺, Mg²⁺, Fe³⁺, Na⁺, Hg²⁺, Cd²⁺, HAsO₄²⁻, Ag⁺, etc.) in water. The representative real time capacitance transient for Hg²⁺ (5-100 ppb) with Pb²⁺ (2.5 ppb) is chosen to demonstrate the selectivity (see FIG. 11B). As shown in the plot, relative change in capacitance in Hg²⁺ ion solution is quite insignificant compared with that of Pb²⁺. Even to the mixed metal ion solution (with all the other metal ions except Pb²⁺), the response from the sensing platform is still very weak (see FIG. 11B). It is favorable that the response to lead ions is much higher than other metal ions, which confirms the good selectivity of the sensor due to the special GSH binding with Pb²⁺. Real-time capacitance transients sensing plots from various common metal ions (Na⁺, Mg²⁺, Zn²⁺, Fe³⁺) and other heavy metal ions (Cd²⁺, HAsO₄³⁻) (˜10 ppb of each) are shown in FIG. 12A, respectively, to demonstrate the selectivity. A mixed ions solution (10 ppb of each) testing is shown in FIG. 12B. The influences from these interfering ions are less significant as compared to Pb²⁺ described herein. FIG. 13A shows a response % comparison of Pb²⁺ (2.5 ppb) with other metal ions (10 ppb). The calculated response from these individual interfering ions and mixed ions did not show any significant sensitivity. The present chemo-capacitance based FET sensor platform shows advantages as compared with previous reports in terms of a higher response, selectivity, and a shorter evaluation time.

To verify the practical performance of these sensors, various real water samples from natural and domestic sources may be tested with the disclosed platform, including the recent tap water from the city of Flint, fresh tap water from Milwaukee, and other natural water samples from Lake Michigan and the Milwaukee River. The Flint water samples were collected from Flint homes using first draw method after stagnation. The real-time response % calculated from real-time capacitance transients for these water samples are displayed in FIG. 13B. FIG. 13C shows real-time measured capacitance data from UWM tap water, Lake Michigan water, Milwaukee river water and Flint tap water to demonstrate the real-time application for Pb²⁺ testing. The predictions calculated from the test water response are compared with those from ICP measurements. As found from ICP measurements (see Table 2 below), the lead ion concentration in the Flint tap water is higher (2.38 ppb) than other samples (<0.8 ppb); therefore, it shows higher response than the other water samples; the Milwaukee tap water did not show detectable lead from ICP measurement and the response % is very feeble (R˜30%), which may be due to the other interfering ions. Subsequently, the response % becomes higher for Flint water (R ˜ 180%) and other water samples (river and lake water, R˜100-130%) owing to the presence of relatively higher amounts of lead ions (0.4-2.38 ppb). FIG. 13D shows the comparison of the results tested by the sensor with that from ICP measurements. The predicted data points with error bars (measured with 10 devices) locate closely to the ideal prediction line, which suggests that the sensor may be used for evaluating lead ions in real water samples.

TABLE 2
MEASURED CONCENTRATIONS OF VARIOUS
METAL IONS FROM REAL WATER SAMPLES
BY ICP-MS MEASUREMENTS

| | Flint Tap | | Milwaukee | | Milwaukee | | Lake | |
|---|---|---|---|---|---|---|---|---|
| Metal Ions | Water | | Tap Water | | River Water | | Michigan | |
| Pb | 2.38 | ppb | — | | 0.48 | ppb | 0.79 | ppb |
| Ag | 0.61 | ppb | 0.16 | ppb | 0.14 | ppb | 0.48 | ppb |
| Cd | 0.20 | ppb | 0.12 | ppb | 0.053 | ppb | 0.07 | ppb |
| As | 0.30 | ppb | 0.32 | ppb | 0.21 | ppb | 0.87 | ppb |
| Zn | 62.61 | ppb | 78.83 | ppb | — | | 12.19 | ppb |
| Fe | 27.36 | ppb | 89.74 | ppb | — | | 66.80 | ppb |
| Cr | 0.33 | ppb | 0.30 | ppb | 0.155 | ppb | 1.77 | ppb |
| Na | 4.08 | ppm | 4.75 | ppm | 10.06 | ppm | 28.34 | ppm |
| K | 1.23 | ppm | 0.65 | ppm | 1.21 | ppm | 5.12 | ppm |
| Mg | 0.71 | ppm | 0.68 | ppm | 1.03 | ppm | 2.54 | ppm |
| Ca | 14.76 | ppm | 16.93 | ppm | 37.37 | ppm | 81.71 | ppm |

Table 1 illustrates benchmarks of the disclosed implementations with conventional FET structures with direct current (DC) resistance measurements. As illustrated in Table 1, the present capacitive measurement with improved single layer GO deposition strategy shows one order of magnitude higher response with step-like transient, excellent selectivity, and much shorter evaluation time. The minimization of Joule heating by using pulse as compared to common continuous voltage (DC measurement) may also be another reason for the quick and sustaining response in signal stabilization. Additionally, from the microcontroller-based device perspective, the system is small, programmable, portable, and able to recognize the Pb²⁺ real time. Advantageously, the present FET system supports direct use by an end user, which is a literature remarkable improvement over previous reports. When compared to other methods (non-FET), such as voltammetry, the system is maintenance-free and is not affected by drifting and background current instability. The present system shows great advantages for rapid heavy metal testing of onsite water quality, portable digital recording, and operational ease.

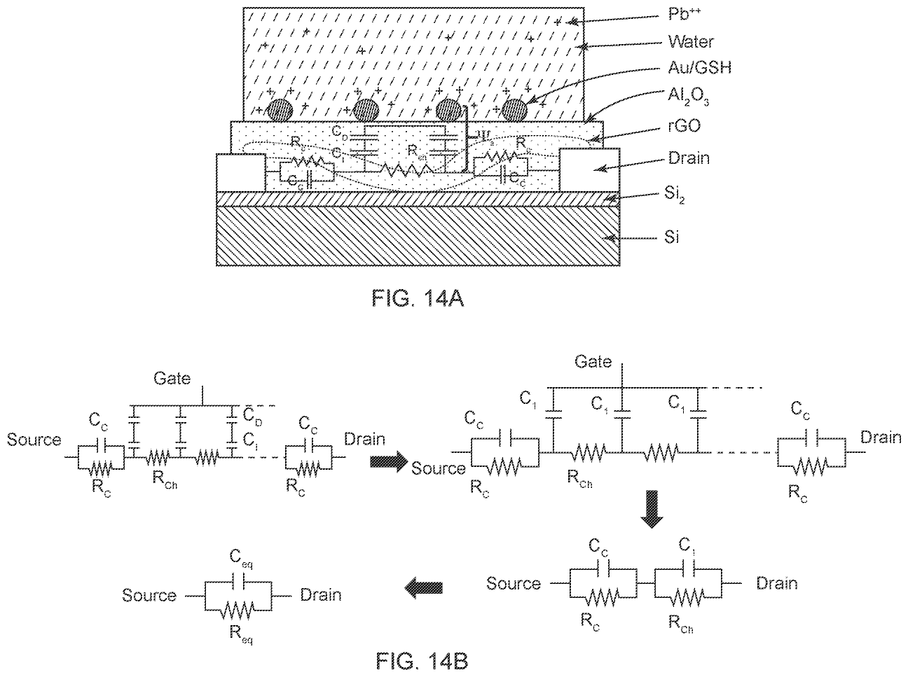

FIG. 14A is a diagram of an equivalent circuit model of the FET system and top gate potential influence on the sensing performance. There is apparently no influence of the back gate terminal (Si/SiO₂) on sensing measurements as it is not exposed to the sensing environment and is kept at 0 V. The current in the channel is changed by the top-gate (ultrathin Al₂O₃ oxide layer) capacitive coupling with rGO channel. There might be some other aspects, for example, influence from the rGO/Au electrode contact. So, the system is electrically equivalent to a resistance-capacitance pair (R_{C}) from channel/oxide interface (R_{Ch} and C₁) and channel-contact interface (R_{C} and C_{C}). Here, R_{Ch} and R_{C} are the channel and contact resistance, respectively. C₁ is an electric double layer (EDL) capacitance formed at the rGO/Al₂O₃ interface. The EDL capacitor consists of stern layer (C₁, formed due to charge transfer near the p-type rGO and n-type Al₂O₃ interface) and diffuse layer (C_{D}, formed away from the channel toward Al₂O₃ matrix where holes are diffused in a cloud of opposite charges). Diffuse layer capacitor forms far from the channel and is primarily affected by the environmental factors. Both capacitors are connected in series but parallel to the rGO channel resistance. Therefore, the capacitance at the rGO/Al₂O₃ interface (C₁) can be expressed as C₁·C_{D}/(C₁+C_{D}). FIG. 14B shows the equivalent circuit model which consists of two RC parallel networks connected in series and finally the entire system may be expressed as a single equivalent RC pair (R_{eq} and C_{eq}). The incoming periodic pulse will face the resultant or equivalent RC time constant from the superposition of these contributions. In the presence of a higher dielectric medium like water, the capacitance of the top gate becomes higher and the interface capacitance is significantly influenced by periodic signal. When the Pb²⁺ are further attracted by GSH probes, the amount of negative charges at the channel increases due to ion-induced top gate positive potential and the total capacitance further increases owing to the increase of C_{D}. The diffusion capacitance (C_{D}) and positive ion induced gate voltage (ψₐ) may be expressed from the Gouy-Chapman model.

$${C}_{D} = ( \frac{ɛ {ɛ}_{0}}{{λ}_{D}} ) coth ( \frac{l}{{λ}_{D}} ) coth ( \frac{e {ψ}_{a}}{2 {k}_{b} T} ) \qquad ( 2 )$$

where ε and ε₀ are the relative dielectric constant of the material and vacuum permittivity, respectively, λ_{D} is the Debye length, l is thickness of the capacitor region, e is electronic charge, k_{B} is Boltzmann constant, and T is the absolute temperature. Therefore, it is presumed that medium (DI water) induces larger dielectric constant and the electrostatic top gate field (ψₐ, due to electrostatically positively charged Pb²⁺) increases the magnitude of EDL capacitances (C₁). This change in capacitance eventually affects the equivalent capacitance (C_{eq}) and the overall time constant of the system becomes larger. Thus, the incoming periodic pulse signal faces a greater time constant and further delayed charging and discharging. The microcontroller calculates this change in capacitance (C_{eq}) with calculated time constant (τ_{eq}).

For pulse measurement and visualization of morphed signal, a standard function generator (for example, the 3390 standard function generator by Keithley, USA) and a digital oscilloscope (for example, the DSO 1052B by Agilent, USA) may be used. The Arduino Uno microcontroller (for example, the Atmega 328P by ATMEL, USA) development board may used for automated pulse based capacitance measurement in real-time. Arduino is an open-source electronics platform based on user friendly hardware and software. The microcontroller is programmed in such a way that it continuously gives the square voltage pulse to sensor, measures the RC time constant (τ_{RC}) and then calculates the capacitance with internal resistance as a reference. For real-time monitoring, a capacitance meter is fabricated using this Arduino Uno board which may take capacitance measurements down to the pF range. The Arduino has several analog input pins which are used to take the measurements. For this meter, two I/O pins may be used (A0 and A1). The voltage is applied at zero to start, and then voltage pulse is applied to the A1 pin. This voltage is then converted into a quantized value by the 10-bit ADC on the microcontroller of the Arduino. From the capacitor charging equation, V_{c}(t)=Vᵢₙ(1−exp(−τ/RC)) where, V_{c}(t) is the voltage across a capacitor at time t, Vᵢₙ is the input voltage, R is the reference internal resistance of the controller, C is the capacitance of the sensor and τ is the time constant when V_{c} reaches 63.2% of the input voltage. Then, the capacitance may be evaluated from the relation

$$C = - \frac{τ}{R ln ( 1 - \frac{{V}_{C}}{{V}_{i n}} )} \qquad ( 3 )$$

The calculated capacitance values are displayed and sent via HyperTerminal of the computer for data storage. The program for signal generation, mathematical calculation of capacitance, and data transmission may be written in the C language in the Arduino platform. HyperTerminal software (for example, by Hilgraeve, Monroe, Mich., USA) may be used for data acquisition with a laptop. The software code is written in C program. Therefore, a continuous capacitive measurement with the meter is feasible with this miniaturized micro-controller based system.

Various embodiments and features are set forth in the following claims.

What is claimed is:

1. A system for detecting ions in a sample, the system comprising:
a field-effect transistor sensor in contact with the sample and including a first electrode and a second electrode; and
an electronic controller coupled to the field-effect transistor sensor and configured to
apply a pulse wave excitation signal to the first electrode,
receive a response signal from the second electrode,
determine an electrical characteristic of the field-effect transistor sensor based on the response signal, and
determine an amount of the ions in the sample based on the electrical characteristic of the field-effect transistor sensor.

2. The system of claim 1, wherein the pulse wave excitation signal is a direct current square wave signal.

3. The system of claim 1, wherein the electrical characteristic of the field-effect transistor sensor is a capacitance.

4. The system of claim 1, wherein the electronic controller is further configured to
determine a change in an electrical characteristic of the response signal,
determine a signal characteristic of the response signal based on the change in the electrical characteristic of the response signal, and
determine the electrical characteristic of the field-effect transistor sensor based on the signal characteristic of the response signal.

5. The system of claim 4, wherein the signal characteristic of the response signal is a time constant.

6. The system of claim 1, wherein the ions are lead ions.

7. The system of claim 1, wherein the sample comprises a liquid medium.

8. The system of claim 1, wherein the field-effect transistor sensor further includes
a reduced graphene oxide layer coated with a passivation layer,
one or more gold nanoparticles in contact with the passivation layer, and
at least one probe bound to the one or more gold nanoparticles, wherein the one or more gold nanoparticles are discrete nanoparticles.

9. The system of claim 8, wherein the passivation layer is aluminum oxide.

10. The system of claim 8, wherein the reduced graphene oxide layer is produced by submerging the field-effect transistor sensor in a graphene oxide solution for a predetermined period of time.

11. A method for detecting ions in a sample, the method comprising:
contacting a field-effect transistor sensor with the sample;
applying, with an electronic controller, a pulse wave excitation signal to a first electrode of the field-effect transistor sensor;
receiving, at the electronic controller, a response signal from a second electrode of the field-effect transistor sensor;
determining, with the electronic controller, an electrical characteristic of the field-effect transistor sensor based on the response signal; and
determining, with the electronic controller, an amount of the ions in the sample based on the electrical characteristic of the field-effect transistor sensor.

12. The method of claim 11, wherein the pulse wave excitation signal is a direct current square wave signal.

13. The method of claim 11, wherein the electrical characteristic of the field-effect transistor sensor is a capacitance.

14. The method of claim 11, further comprising
determining, with the electronic controller, a change in an electrical characteristic of the response signal;
determining, with the electronic controller, a signal characteristic of the response signal based on the change in the electrical characteristic of the response signal; and
determining, with the electronic controller, the electrical characteristic of the field-effect transistor sensor based on the signal characteristic of the response signal.

15. The method of claim 14, wherein the signal characteristic of the response signal is a time constant.

16. The method of claim 11, wherein the ions are lead ions.

17. The method of claim 11, wherein the sample comprises a liquid medium.

18. The method of claim 11, wherein the field-effect transistor sensor further includes
a reduced graphene oxide layer coated with a passivation layer,
one or more gold nanoparticles in contact with the passivation layer, and
at least one probe bound to the one or more gold nanoparticles, wherein the one or more gold nanoparticles are discrete nanoparticles.

19. The method of claim 18, wherein the passivation layer is aluminum oxide.
